(19) United States
(12) Patent Application Publication
(10) Pub. No.: US 2019/0292355 A1
(43) Pub. Date: Sep. 26, 2019

(54) RUBBER COMPOSITION, COVER RUBBER FOR CONVEYOR BELT, AND CONVEYOR BELT

(71) Applicant: BRIDGESTONE CORPORATION, Tokyo (JP)

(72) Inventor: Shihono NARUSE, Tokyo (JP)

(73) Assignee: BRIDGESTONE CORPORATION, Tokyo (JP)

(21) Appl. No.: 16/434,335

(22) Filed: Jun. 7, 2019

Related U.S. Application Data
(63) Continuation of application No. PCT/JP2017/043910, filed on Dec. 7, 2017.

(30) Foreign Application Priority Data
Dec. 13, 2016 (JP) 2016-241098

(51) Int. Cl. C08L 9/00; B65G 15/34

(52) U.S. Cl. CPC C08L 9/00; B65G 15/34

(57) ABSTRACT

A rubber composition containing a butadiene rubber in an amount of 60% by mass or more relative to the total amount of a rubber component therein, and containing, relative to 100 parts by mass of the rubber component, a carbon black having an iodine adsorption of 100 to 170 g/kg and a DBP oil absorption of 100 to 140 cm³/100 g, in an amount of 40 to 70 parts by mass, sulfur in an amount of 0.3 to 2.0 parts by mass, and a vulcanization accelerator in an amount of 1.5 to 3 parts by mass.

### TECHNICAL FIELD

The present invention relates to a rubber composition, a cover rubber for conveyor belt, and a conveyor belt.

### BACKGROUND ART

A belt conveyor is extremely useful as a means for transporting articles and is used in many places.

The belt of a belt conveyor (hereinafter referred to as a conveyor belt) is generally formed of a cover rubber and a reinforcing material. Of these, especially the cover rubber is readily worn away by friction against the loaded articles to be transported, and the abrasion of the cover rubber has a significant influence on the useful life of the conveyor belt. Consequently, heretofore, various techniques have been investigated for improving the abrasion resistance of cover rubber.

As a rubber composition excellent in abrasion resistance, heretofore, a rubber composition containing, as a rubber component, a polybutadiene rubber synthesized with a neodymium catalyst (PTL 1), and a rubber composition prepared by containing a specific carbon black, silica and a specific resin each in a specific amount into a rubber component containing, as a main ingredient, a butadiene rubber produced through polymerization with a neodymium catalyst, and containing a natural rubber along with the butadiene rubber produced through polymerization with a neodymium catalyst (PTL 2) have been proposed.

### CITATION LIST

### Patent Literature

PTL 1: JP-A 2003-105136
PTL 2: JP-A 2014-210879

### SUMMARY OF INVENTION

### Technical Problem

However, all the conventional rubber compositions often undergo decomposition of polymers and crosslinked parts (hereinafter this may be referred to as reversion) in over-vulcanization where vulcanization is increased over a suitable state, and therefore have a problem in that they are unsuitable for use in large-sized conveyor belts that may often undergo over-vulcanization.

In addition, as a rubber composition for high-end products, a rubber composition more excellent in abrasion resistance than conventional products is desired.

An object of the present invention is to provide a rubber composition that can prevent reversion in over-vulcanization and is excellent in abrasion resistance both in ordinary vulcanization and in over-vulcanization. In addition, an object of the present invention is to satisfy both the above-mentioned characteristics and a processability required for a rubber composition.

### Solution to Problem

The present inventors have assiduously studied and, as a result, have found that, by containing a specific amount of a specific carbon black, and containing sulfur and a vulcanization accelerator each in a specific amount into a rubber composition containing a butadiene rubber, the above-mentioned problem can be solved.

Specifically, the present invention relates to the following <1> to <10>.
<1> A rubber composition containing a butadiene rubber in an amount of 60% by mass or more relative to the total amount of a rubber component therein, and containing, relative to 100 parts by mass of the rubber component, a carbon black having an iodine adsorption of 100 to 170 g/kg and a DBP oil absorption of 100 to 140 cm³/100 g, in an amount of 40 to 70 parts by mass, sulfur in an amount of 0.3 to 2.0 parts by mass, and a vulcanization accelerator in an amount of 1.5 to 3 parts by mass.
<2> The rubber composition according to <1>, wherein the ratio by mass of the sulfur and the vulcanization accelerator, sulfur/vulcanization accelerator is from 0.2 to 0.9.
<3> The rubber composition according to <1>, comprising the sulfur in an amount of 0.3 to 1.5 parts by mass.
<4> The rubber composition according to <3>, wherein the ratio by mass of the sulfur and the vulcanization accelerator, sulfur/vulcanization accelerator is from 0.2 to 0.6.
<5> The rubber composition according to any one of <1> to <4>, wherein the rubber component contains a natural rubber.
<6> The rubber composition according to any one of <1> to <5>, wherein the vulcanization accelerator is a sulfenamide vulcanization accelerator.
<7> The rubber composition according to any one of <1> to <6>, further containing a thermoplastic material.
<8> The rubber composition according to any one of <1> to <7>, wherein the iodine adsorption of the carbon black is from 120 to 170 g/kg.
<9> A cover rubber for conveyor belt, comprising a rubber composition of any one of <1> to <8>.
<10> A conveyor belt, comprising a rubber composition of any one of <1> to <8>.

### Advantageous Effects of Invention

According to the present invention, there can be provided a rubber composition that can prevent reversion in over-vulcanization and is excellent in abrasion resistance both in ordinary vulcanization and in over-vulcanization. In addition, according to the present invention, both the above-mentioned characteristics (reversion prevention and abrasion resistance) and a processability required for a rubber composition can be satisfied.

### DESCRIPTION OF EMBODIMENTS

Hereinunder the present invention is described in detail with reference to embodiments thereof. In the following description, the expression of “A to B” to indicate a numerical range represents the numerical range including the end points A and B, and represents “A or more and B or less” (in the case of A<B) or “A or less and B or more” in the case of A<B).

Part by mass and % by mass are the same as part by weight and % by weight, respectively.

### [Rubber Composition]

The rubber composition of the present invention is favorably used for conveyor belts, especially for cover rubber of conveyor belts.

The rubber composition of the present invention contains a butadiene rubber in an amount of 60% by mass or more relative to the total amount of the rubber component therein, and contains, relative to 100 parts by mass of the rubber component, a carbon black having an iodine adsorption of 100 to 170 g/kg and a DBP oil absorption of 100 to 140 cm³/100 g, in an amount of 40 to 70 parts by mass, sulfur in an amount of 0.3 to 2.0 parts by mass, and a vulcanization accelerator in an amount of 1.5 to 3.0 parts by mass.

Using a rubber component that contains a butadiene rubber excellent in abrasion resistance in a rubber composition for conveyor belt has heretofore been widely carried out, but the conventional rubber compositions of the type are all problematic in that they often undergo reversion in over-vulcanization.

In addition, increase in the proportion of butadiene rubber in the rubber component causes processability degradation, and therefore in the conventional rubber compositions, the content of butadiene rubber is generally 60 parts by mass or less relative to 100 parts by mass of the rubber component. When the content of butadiene rubber is 60 parts by mass or less relative to 100 parts by mass of the rubber component, there are problems in that reversion often occurs in over-vulcanization and abrasion resistance necessary for rubber compositions for high-end products could not be realized.

The present inventors have assiduously studied and, as a result, have found that, in producing a rubber composition that contains a predetermined amount of butadiene rubber, when a predetermined carbon black is used and when a vulcanization system where the content of sulfur and that of the vulcanization accelerator are specifically defined each to fall within a predetermined range is used, then occurrence of reversion in over-vulcanization can be prevented and abrasion resistance is improved, and have completed the present invention.

### <Rubber Component>

The rubber component in the rubber composition of the present invention contains a butadiene rubber (BR).

The butadiene rubber content is 60% by mass or more relative to the total amount of the rubber component. When the content is less than 60% by mass, sufficient abrasion resistance could not be obtained. From the viewpoint of the abrasion resistance and the processability of the conveyor belt to be formed, the butadiene rubber content relative to the total amount of the rubber component is preferably 60 to 90% by mass, more preferably 60 to 85% by mass.

The butadiene rubber is not specifically limited as long as it is a polymer of a butadiene-type monomer. In addition, those produced using plural types of butadiene-type monomers may be used.

Examples of the butadiene-type monomer include 1,3-butadiene, 2-methyl-1,3-butadiene, 2,3-dimethyl-1,3-butadiene, 2-chloro-1,3-butadiene, etc.

The weight average molecular weight of the butadiene rubber is, from the viewpoint of the strength of the conveyor belt to be formed and the handleability of the composition, preferably 400,000 or more, more preferably 450,000 or more. The upper limit is not specifically limited, and is preferably 2,000,000 or less.

In the present invention, the weight average molecular weight (Mw) is a standard polystyrene-equivalent one determined through gel permeation chromatography (GPC) using tetrahydrofuran as a solvent.

Preferably, the glass transition temperature (Tg) of the butadiene rubber is −65° C. or lower, more preferably −90° C. or lower. The lower limit of Tg is not specifically limited, and is generally −130° C. or higher. In the present invention, Tg is measured at a heating rate of 20° C./min using a differential scanning calorimeter (DSC), and calculated according to a midpoint method.

The rubber component may contain any other rubber than butadiene rubber as long as the content of the butadiene rubber is 60% by mass or more.

The other rubber is not specifically limited, and examples thereof include natural rubber (NR), styrene-butadiene rubber (SBR), isoprene rubber (IR), acrylonitrile-butadiene copolymer rubber (NBR), butyl rubber (IIR), halogenated butyl rubber (Br-IIR, Cl-IIR), chloroprene rubber (CR), etc. Among these, natural rubber (NR) is preferred from the viewpoint of improving processability. From the viewpoint of improving abrasion resistance, styrene-butadiene rubber (SBR) is preferred.

### <Carbon Black>

The rubber composition of the present invention contains a carbon black having an iodine adsorption of 100 to 170 g/kg and a DBP (dibutyl phthalate) oil absorption of 100 to 140 cm³/100 g. When the iodine adsorption is less than 100 g/kg, sufficient abrasion resistance could not be secured. When the iodine adsorption is more than 170 g/kg, processability could not be secured. When the DBP oil absorption is less than 100 cm³/100 g, sufficient abrasion resistance could not be secured. When the DBP oil absorption is more than 140 cm³/100 g, the viscosity is high and processing would be difficult.

From the viewpoint of abrasion resistance and processability, the iodine adsorption is preferably 120 to 170 g/kg, more preferably 130 to 150 g/kg. The DBP absorption is preferably 100 to 130 cm³/100 g. Further, the nitrogen adsorption surface area is preferably 100 to 150 m²/g.

The characteristics of the carbon black to be used in the present invention are analyzed according to the following methods.
a) Iodine adsorption (IA)

Measured according to JIS K6221-1982.
b) DBP (dibutyl phthalate) oil absorption

Measured according to ASTM-D-3493.
c) Nitrogen adsorption surface area (N₂SA)

Measured according to ASTM-D3037-86.

Examples of the carbon black satisfying the physical properties include SAF, ISAF, etc., and SAF is especially preferred. The carbon black may be used singly or two or more thereof may be used in combination.

The content of the carbon black is 40 to 70 parts by mass relative to 100 parts by mass of the rubber component. When the carbon black content is less than 40 parts by mass, sufficient abrasion resistance could not be imparted to the rubber composition. When the carbon black content is more than 70 parts by mass, the requirement for processability could not be satisfied. From the viewpoint of satisfying both abrasion resistance and processability, the content is preferably 40 to 60 parts by mass.

### <Sulfur>

The rubber composition of the present invention contains sulfur.

The content of sulfur is 0.3 to 2.0 parts by mass relative to 100 parts by mass of the rubber component. When the sulfur content is less than 0.3 parts by mass, sufficient crosslinks could not be formed. When the sulfur content is more than 2.0 parts by mass, reversion could not be prevented. From the viewpoint of the strength of the conveyor belt to be formed and the handleability of the composition, the content is preferably 0.5 to 1.7 parts by mass. The upper limit of the sulfur content is more preferably less than 1.2 parts by mass.

The sulfur to be contained in the rubber composition of the present invention is not specifically limited, and examples thereof include powdery sulfur, precipitated sulfur, highly-dispersive sulfur, surface-treated sulfur, insoluble sulfur, dimorpholine disulfide, alkylphenol disulfide, etc. One of them may be used singly or two or more thereof may be used in combination.

### <Vulcanization Accelerator>

The rubber composition of the present invention contains a vulcanization accelerator.

The content of the vulcanization accelerator is 1.5 to 3.0 parts by mass relative to 100 parts by mass of the rubber component. When the vulcanization accelerator content is less than 1.5 parts by mass, reversion could not be prevented. When the vulcanization accelerator content is more than 3.0 parts by mass, elongation would lower and the bending fatigue resistance of conveyor belt may lower. From the viewpoint of the strength of the conveyor belt to be formed and the handleability of the composition, the content is preferably 1.5 to 2.8 parts by mass, and is more preferably 1.9 to 2.8 parts by mass.

The vulcanization promoter to be contained in the composition of the present invention is not specifically limited, and examples thereof include aldehyde/ammonia-type, guanidine-type, thiourea-type, thiazole-type, sulfenamide-type, and thiuram-type, dithiocarbamate-type vulcanization accelerators. Among these, in particular, sulfenamide-type vulcanization accelerators are preferred.

Specific examples of the aldehyde/ammonia-type vulcanization accelerator include hexamethylenetetramine(H), etc.

Specific examples of the guanidine-type vulcanization accelerator include diphenylguanidine, etc.

Specific examples of the thiourea-type vulcanization accelerator include ethylene thiourea, etc.

Specific examples of the thiazole-type vulcanization accelerator include dibenzothiazyl disulfide (DM), 2-mercaptobenzothiazole and Zn salt thereof, etc.

Specific examples of the sulfenamide-type vulcanization accelerator include N-cyclohexyl-2-benzothiazolylsulfenamide (CZ), N-t-butyl-2-benzothiazolylsulfenamide (NS), etc.

Specific examples of the thiuram-type vulcanization accelerator include tetramethylthiuram disulfide (TMTD), dipentamethylenethiuram tetrasulfide, etc.

Specific examples of the dithiocarbamate-type vulcanization accelerator include Na-dimethyldithiocarbamate, Zn-dimethyldithiocarbamate, Te-diethyldithiocarbamate, Cu-dimethyldithiocarbamate, Fe-dimethyldithiocarbamate, pipecholine pipecholyldithiocarbamate, etc. One of of the vulcanization accelerators may be used singly or two or more thereof may be used in combination.

### <Sulfur/Vulcanization Accelerator>

In the rubber composition of the present invention, the ratio by mass of the sulfur content to the vulcanization accelerator content, sulfur/vulcanization accelerator is preferably from 0.2 to 0.9, more preferably from 0.2 to 0.6.

By defining the ratio by mass of the sulfur content to the vulcanization accelerator content to fall within the above range, occurrence of reversion attributable to increase in the amount of butadiene rubber to be used and increase in the vulcanization time can be prevented.

### <Thermoplastic Material>

Preferably, the rubber composition of the present invention contains a thermoplastic material. Needless-to-say, the “thermoplastic material” in this description does not contain the above-mentioned rubber component.

The content of the thermoplastic material to be contained in the rubber composition of the present invention is preferably 2.0 to 20.0 parts by mass relative to 100 parts by mass of the rubber component, more preferably 4.0 to 15.0 parts by mass.

Examples of the thermoplastic material include dicyclopentadiene resins, indene resins, coumarone resins, rosin resins, paraffin resins, fatty acid metal salts, novolak-phenol resins, fatty acid amides, and composite resins thereof, etc.

The thermoplastic material is preferably a thermoplastic resin.

Butadiene rubber is known as a rubber excellent in abrasion resistance, but with the increase in the butadiene rubber content in the rubber composition, the processability of the rubber composition tends to worsen. By adding the above-mentioned thermoplastic material in the amount mentioned above, processability degradation attributable to the increase in the amount of the butadiene rubber to be used may be prevented.

### <Other Components>

The composition of the present invention may contain any other components than the above-mentioned components, such as silica, silane coupling agent, vulcanizing agent except the above-mentioned sulfur, vulcanization aid, vulcanization retardant, etc., and may further contain various compounding ingredients within a range not detracting from the object of the present invention.

### (Silica)

The silica is not specifically limited, and examples thereof include fumed silica, baked silica, precipitated silica, ground silica, molten silica, anhydrous powdery silicic acid, hydrous powdery silicic acid, hydrous aluminum silicate, hydrous calcium silicate, etc. One of them may be used singly or two or more thereof may be used in combination.

### (Silane Coupling Agent)

The silane coupling agent is not specifically limited, and it is preferable to use a polysulfide-type silane coupling agent for use for rubber.

Specific examples of the polysulfide-type silane coupling agent include bis(3-triethoxysilylpropyl) tetrasulfide, bis(3-triethoxysilylpropyl) disulfide, etc.

### (Vulcanizing Agent Except Sulfur)

The vulcanizing agent except the above-mentioned sulfur is not specifically limited, and examples thereof include organic peroxides, metal oxides, phenolic resins, quinone dioximes and the like.

Specific examples of the organic peroxide-type vulcanizing agents include benzoyl peroxide, t-butyl hydroperoxide, 2,4-dichlorobenzoyl peroxide, 2,5-dimethyl-2,5-di(t-butylperoxy)hexane, 2,5-dimethylhexane-2,5-di(peroxyl benzoate), etc.

Examples of the others include magnesium oxide, lead oxide, p-quinone dioxime, p-dibenzoylquinone dioxime, poly-p-dinitrosobenzene, methylenedianiline, etc.

### (Vulcanization Aid)

As the vulcanization aid, any ordinary aid for rubber may be used in combination, and examples thereof include zinc oxide, stearic acid, oleic acid, Zn salts thereof, etc.

### (Vulcanization Retardant)

Specific examples of the vulcanization retardant include organic acids such as phthalic anhydride, benzoic acid, salicylic acid, acetylsalicylic acid, etc.; nitroso compounds such as N-nitroso-diphenylamine, N-nitroso-phenyl-β-naphthylamine, N-nitroso-trimethyl-dihydroquinoline polymers, etc.; halides such as trichloromelanin, etc.; 2-mercaptobenzimidazole; Santogard PVI; etc.

### (Other Compounding Ingredients)

Examples of the other compounding ingredients include fillers except the above-mentioned carbon black, antiaging agents, antioxidants, pigments (dyes), plasticizers, thixotropy-imparting agents, UV absorbents, flame retardants, solvents, surfactants (including leveling agents), dispersants, dewatering agents, rust inhibitors, adhesion-imparting agents, antistatic agents, processing aids, etc.

As these compounding ingredients, general ones for rubber composition can be used. The blending amount of these is not specifically limited, and may be selected arbitrarily.

### <Use>

The rubber composition of the present invention is excellent both in abrasion resistance in ordinary vulcanization and in abrasion resistance in over-vulcanization, and is especially favorable for use for large-size conveyor belts and high-end products.

### [Preparation of Rubber Composition, Formation of Conveyor Belt]

The rubber composition of the present invention can be obtained by kneading the components using a kneading machine, such as an open mixer-type kneading roll machine or a closed mixer-type Bunbary mixer, etc. The resultant rubber composition may be molded into a sheet using a calender roller, an extruder or the like, and the sheet-shaped rubber molded article is stuck to a reinforcing material of a canvas cloth or a steel cord serving as a core material so as to cover it, and is thereafter vulcanized to produce a belt.

The conveyor belt is generally composed of an upper cover rubber, a reinforcing material and a lower cover rubber. By using the rubber composition of the present invention as the upper cover rubber that is to be kept in contact with objects to be transported, the lifetime of the conveyor belt can be prolonged.

The rubber composition of the present invention can be favorably used for conveyor belts, especially for cover rubber for conveyor belts, but is not limited thereto.

### EXAMPLES

The present invention is described in more detail with reference to Examples given hereunder, but the present invention is not whatsoever limited to the following Examples.

Examples and Comparative Examples other than Examples 1 to 3, 6, 8, and 12 to 22, and Comparative Examples 1, 4, 6 and 9 are prophetic.

### [Compounding Ingredients of Rubber Composition]

The components to be contained in the rubber compositions of Examples and Comparative Examples are as follows.
NR: Natural rubber, RSS#4
BR: Polybutadiene rubber, manufactured by Ube Industries, Ltd., trade name “UBEPOL-BR150L”
SBR: JSR1502 (manufactured by JSR Corporation, styrene content 23.5% by mass)
SAF CB: Carbon black, manufactured by Cabot Corporation, trade name “VULCAN 1011” (iodine adsorption: 142 g/kg, DBP oil absorption: 127 cm³/100 g, nitrogen adsorption surface area: 146 m²/g)
ISAF CB: Carbon black, manufactured by Tokai Carbon Co., Ltd., trade name “SEAST 6” (iodine adsorption: 121 g/kg, DBP oil absorption: 114 cm³/100 g, nitrogen adsorption surface area: 115 m²/g)
HAF CB: Carbon black, manufactured by Tokai Carbon Co., Ltd., trade name “SEAST NB” (iodine adsorption: 70 g/kg, DBP oil absorption: 103 cm³/100 g, nitrogen adsorption surface area: 66 m²/g)
Sulfur: Manufactured by Tsurumi Chemical Industry Co., Ltd., trade name: “SULFAX 5”
Vulcanization Accelerator: NS, N-tert-butyl-2-benzothiazolyl sulfenamide, manufactured by Ouchi Shinko Chemical Industrial Co., Ltd., trade name “NOCCELER NS-F”
DCDP: Dicyclopentadiene resin, manufactured by Maruzen Petrochemical Co., Ltd., trade name “MARUKAREZ M-890A”
Rosin: Manufactured by Airec Co., Ltd., trade name “HIGHROSIN S”
Fatty acid metal salt: Manufactured by S & S Japan Co., Ltd., trade name “STRUKTOL A50P”
Zinc Oxide: Manufactured by Toho Zinc Co., Ltd., trade name “GINREI SR”
Stearic Acid: Manufactured by New Japan Chemical Co., Ltd., trade name “STEARIC ACID 50S”
Wax: Manufactured by Seiko Chemical Co., Ltd., trade name “SUNTIGHT S”
Antiaging Agent: N-(1,3-dimethylbutyl)-N′-phenyl-p-phenylenediamine, manufactured by Sumitomo Chemical Co., Ltd., trade name “ANTIGENE 6C”

### [Evaluation]

In the following Examples and Comparative Examples, evaluations were carried out as follows.

### (1) DIN Abrasion Value

Using a DIN abrasion tester, an abrasion resistance test was carried out at room temperature according to DIN53516.

In Tables 1 to 3, “2B” means ordinary vulcanization (vulcanization at 167° C. for 10 minutes).

The evaluation in Tables 1 to 3 shows the index that indicates the abrasion value of each rubber composition, taking the abrasion value of the rubber composition of Example 1 in ordinary vulcanization (2B) as 100. Samples having a smaller numerical value have better abrasion resistance. For high-end use, the value is preferably 110 or less.

### (2) DIN Abrasion Change Rate in Over-Vulcanization

Using a DIN abrasion tester, an abrasion resistance test was carried out.

In Tables 1 to 3, “4B” means over-vulcanization at 167° C. for 20 minutes. In Tables 1 to 3, “8B” means over-vulcanization at 167° C. for 40 minutes.

With respect to each of the rubber compositions of Examples 1 to 22 and Comparative Examples 1 to 10, the DIN abrasion value was measured in over-vulcanization (4B and 8B), and the change rate (%) of the change from the DIN abrasion value in ordinary vulcanization (2B) to the DIN abrasion value in over-vulcanization (4B and 8B) is shown in the evaluation in Tables 1 to 3. The smaller numerical value means that the reversion in over-vulcanization can be prevented better.

For use for large-size conveyor belts, those having a smaller DIN abrasion change rate in over-vulcanization are preferred, and those having the change rate of less than 20% are especially preferred.

### (3) Mooney Viscosity

The Mooney viscosity (ML₁₊₄/100° C.) was measured using RLM-01 Model Tester (manufactured by Toyo Seiki Co, Ltd.).

For satisfying the requirement of processability, the value is preferably 90 or less.

### (4) Elongation

The elongation (%) was measured with a No. 3 dumbbell form according to JIS K 6251. For satisfying the bending fatigue resistance required for conveyor belts, the value is preferably 430 or more.

### Examples 1 to 22, and Comparative Examples 1 to 10

Using a Banbury mixer, the compounding ingredients for the rubber composition mentioned above were kneaded according to the compounding formulation shown in Table 1 to Table 3, thereby preparing each rubber composition as a sample.

The processability (Mooney viscosity) of the resultant unvulcanized rubber compositions was evaluated.

In addition, the resultant rubber composition was vulcanized at 167° C. for 10 minutes (2B ordinary vulcanization) to give a vulcanized rubber composition, and the vulcanized rubber composition was evaluated in point of the abrasion resistance (DIN abrasion value) and the processability (elongation).

Further, the resultant rubber composition was vulcanized at 167° C. for 20 minutes (4B over-vulcanization) or at 167° C. for 40 minutes (8B over-vulcanization), and evaluated in point of the abrasion resistance (DIN abrasion change rate in over-vulcanization).

TABLE 1

| | | Example | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| For- | NR | 40 | 25 | 10 | | 25 | 25 | 25 | 25 | 25 | 25 | 25 | 25 |
| mulation | BR | 60 | 75 | 90 | 75 | 75 | 75 | 75 | 75 | 75 | 75 | 75 | 75 |
| | SBR | | | | 25 | | | | | | | | |
| | SAF | | | | | | | | | | | | |
| | ISAF | 50 | 50 | 50 | 50 | 50 | 50 | 50 | 50 | 50 | 50 | 50 | 40 |
| | HAF | | | | | | | | | | | | 10 |
| | Sulfur | 1.0 | 1.0 | 1.0 | 1.0 | 0.4 | 0.7 | 1.3 | 2.0 | 1.0 | 1.0 | 1.0 | 1.0 |
| | Vulcanization | 2.0 | 2.0 | 2.0 | 2.0 | 3.0 | 2.5 | 2.0 | 1.6 | 2.0 | 2.0 | 2.0 | 2.0 |
| | Accelerator | | | | | | | | | | | | |
| | Ratio of Sulfur/ | 0.50 | 0.50 | 0.50 | 0.50 | 0.13 | 0.28 | 0.65 | 1.25 | 0.50 | 0.50 | 0.50 | 0.50 |
| | Vulcanization Accelerator | | | | | | | | | | | | |
| | DCPD | 5 | 5 | 5 | 5 | 5 | 5 | 5 | 5 | 0 | | | 5 |
| | Rosin | | | | | | | | | | 5 | | |
| | Fatty acid metal salt | | | | | | | | | | | 5 | |
| | Zinc Oxide | 3 | 3 | 3 | 3 | 3 | 3 | 3 | 3 | 3 | 3 | 3 | 3 |
| | Stearic Acid | 1 | 1 | 1 | 1 | 1 | 1 | 1 | 1 | 1 | 1 | 1 | 1 |
| | Wax | 2 | 2 | 2 | 2 | 2 | 2 | 2 | 2 | 2 | 2 | 2 | 2 |
| | Antiaging Agent | 3 | 3 | 3 | 3 | 3 | 3 | 3 | 3 | 3 | 3 | 3 | 3 |
| Physical | 2 B DIN Abrasion Value | 100 | 65 | 58 | 52 | 76 | 68 | 67 | 63 | 52 | 62 | 68 | 76 |
| Properties | (INDEX) | | | | | | | | | | | | |
| | DIN Abrasion Change Rate | 7% | 1% | −3% | −8% | −10% | −2% | 6% | 8% | −10% | 0% | 2% | 5% |
| | in 2 B vs 4 B Over-Vulcanization | | | | | | | | | | | | |
| | DIN Abrasion Change Rate | 9% | −12% | −7% | −5% | −14% | −13% | 4% | 14% | −2% | 8% | −17% | 7% |
| | in 2 B vs 8 B Over-Vulcanization | | | | | | | | | | | | |
| | Mooney Viscosity M_{1+L} | 71 | 66 | 69 | 70 | 68 | 65 | 62 | 67 | 84 | 73 | 65 | 62 |
| | (127° C.)/M | | | | | | | | | | | | |
| | Elongation/% | 590 | 575 | 530 | 520 | 590 | 580 | 595 | 560 | 440 | 535 | 475 | 590 |

TABLE 2

| | | Example | | | | | | | | | |
|---|---|---|---|---|---|---|---|---|---|---|---|
| | | 13 | 14 | 15 | 16 | 17 | 18 | 19 | 20 | 21 | 22 |
| For- | NR | 25 | 40 | 10 | 25 | 25 | 25 | 25 | 25 | 25 | 25 |
| mulation | BR | 75 | 60 | 90 | 75 | 75 | 75 | 75 | 75 | 75 | 75 |
| | SBR | | | | | | | | | | |
| | SAF | 50 | 50 | 50 | 50 | 50 | 50 | 50 | 50 | 50 | 50 |
| | ISAF | | | | | | | | | | |
| | HAF | | | | | | | | | | |
| | Sulfur | 1.0 | 1.0 | 1.0 | 0.4 | 0.7 | 1.3 | 2.0 | 1.0 | 1.0 | 1.0 |
| | Vulcanization Accelerator | 2.0 | 2.0 | 2.0 | 3.0 | 2.5 | 1.9 | 1.6 | 2.0 | 2.0 | 2.0 |
| | Ratio of Sulfur/ | 0.50 | 0.50 | 0.50 | 0.13 | 0.28 | 0.68 | 1.25 | 0.50 | 0.50 | 0.50 |
| | Vulcanization Accelerator | | | | | | | | | | |
| | DCPD | 10 | 10 | 10 | 10 | 10 | 10 | 10 | 0 | | |
| | Rosin | | | | | | | | | 10 | |
| | Fatty acid metal salt | | | | | | | | | | 10 |
| | Zinc Oxide | 3 | 3 | 3 | 3 | 3 | 3 | 3 | 3 | 3 | 3 |
| | Stearic Acid | 1 | 1 | 1 | 1 | 1 | 1 | 1 | 1 | 1 | 1 |
| | Wax | 2 | 2 | 2 | 2 | 2 | 2 | 2 | 2 | 2 | 2 |
| | Antiaging Agent | 3 | 3 | 3 | 3 | 3 | 3 | 3 | 3 | 3 | 3 |
| Physical | 2 B DIN Abrasion Value | 31 | 49 | 35 | 47 | 34 | 42 | 40 | 31 | 44 | 41 |
| Properties | (INDEX) | | | | | | | | | | |
| | DIN Abrasion Change Rate | −11% | 9% | 0% | −4% | −1% | 3% | 10% | −6% | 0% | −2% |
| | in 2 B vs 4 B Over-Vulcanization | | | | | | | | | | |
| | DIN Abrasion Change Rate | −8% | 13% | −10% | −9% | 13% | 8% | 18% | 9% | −6% | 12% |
| | in 2 B vs 8 B Over-Vulcanization | | | | | | | | | | |
| | Mooney Viscosity M_{1+L} | 81 | 82 | 77 | 75 | 74 | 80 | 78 | 96 | 84 | 72 |
| | (127° C.)/M | | | | | | | | | | |
| | Elongation/% | 550 | 570 | 525 | 555 | 560 | 600 | 540 | 430 | 635 | 490 |

TABLE 3

| | | Comparative Example | | | | | | | | | |
|---|---|---|---|---|---|---|---|---|---|---|---|
| | | 1 | 2 | 3 | 4 | 5 | 6 | 7 | 8 | 9 | 10 |
| For- | NR | 60 | 25 | 25 | 25 | 25 | 25 | 25 | 25 | 25 | 25 |
| mulation | BR | 40 | 75 | 75 | 75 | 75 | 75 | 75 | 75 | 75 | 75 |
| | SBR | | | | | | | | | | |
| | SAF | | | | | | | | | | |
| | ISAF | 50 | 75 | 30 | 0 | 50 | 50 | 50 | 50 | 50 | 50 |
| | HAF | | | 20 | 50 | | | | | | |
| | Sulfur | 1.0 | 1.0 | 1.0 | 1.0 | 2.3 | 0.15 | 2.0 | 0.4 | 2.3 | 0.15 |
| | Vulcanization Accelerator | 2.0 | 2.0 | 2.0 | 2.0 | 1.5 | 3.00 | 1.2 | 3.3 | 1.2 | 3.30 |
| | Ratio of Sulfur/ | 0.50 | 0.50 | 0.50 | 0.50 | 1.53 | 0.05 | 1.67 | 0.12 | 1.92 | 0.05 |
| | Vulcanization Accelerator | | | | | | | | | | |
| | DCPD | 5 | 5 | 5 | 5 | 5 | 5 | 5 | 5 | 5 | 5 |
| | Rosin | | | | | | | | | | |
| | Fatty acid metal salt | | | | | | | | | | |
| | Zinc Oxide | 3 | 3 | 3 | 3 | 3 | 3 | 3 | 3 | 3 | 3 |
| | Stearic Acid | 1 | 1 | 1 | 1 | 1 | 1 | 1 | 1 | 1 | 1 |
| | Wax | 2 | 2 | 2 | 2 | 2 | 2 | 2 | 2 | 2 | 2 |
| | Antiaging Agent | 3 | 3 | 3 | 3 | 3 | 3 | 3 | 3 | 3 | 3 |
| Physical | 2 B DIN Abrasion Value (INDEX) | 123 | 49 | 129 | 167 | 119 | 181 | 165 | 113 | 83 | 174 |
| Properties | DIN Abrasion Change Rate | 6% | 4% | 6% | −10% | 4% | 12% | 9% | −2% | 13% | 3% |
| | in 2 B vs 4 B Over-Vulcanization | | | | | | | | | | |
| | DIN Abrasion Change Rate | 15% | −13% | −5% | −2% | 20% | 9% | 26% | 6% | 32% | 16% |
| | in 2 B vs 8 B Over-Vulcanization | | | | | | | | | | |
| | Mooney Viscosity M_{1+L} | 73 | 116 | 60 | 57 | 66 | 65 | 64 | 64 | 66 | 64 |
| | (127° C.)/M | | | | | | | | | | |
| | Elongation/% | 605 | 450 | 590 | 560 | 445 | 775 | 690 | 545 | 520 | 710 |

The results in Tables 1 to 3 indicate that the sample of each of Examples is a rubber composition that can prevent reversion in over-vulcanization and is, in addition, excellent in abrasion resistance both in ordinary vulcanization and in over-vulcanization.

On the other hand, the rubber compositions of Comparative Example 1 and Comparative Examples 3 to 10 are poor in abrasion resistance in ordinary vulcanization and/or in over-vulcanization. The rubber composition of Comparative Example 2 has a high Mooney viscosity and is difficult to process with a Banbury mixer or a mill roll.

Comparing the results of Table 1 with those of Table 2, it can be seen that, by using SAF as carbon black, the abrasion resistance both in ordinary vulcanization and in over-vulcanization is improved more.

Comparing the results of Table 1 with those of Table 3, it can be seen that, by using a vulcanization system where the content of sulfur and the content of the vulcanization accelerator are controlled each to fall within a predetermined range, rubber compositions that can prevent reversion in over-vulcanization and are excellent in abrasion resistance both in ordinary vulcanization and in over-vulcanization can be obtained.

Further, comparing Example 1 with Comparative Example 1, it can be seen that, when a butadiene rubber is contained in an amount of 60 parts by mass or more relative to 100 parts by mass of the rubber component, rubber compositions excellent in abrasion resistance both in ordinary vulcanization and in over-vulcanization can be obtained.

### INDUSTRIAL APPLICABILITY

According to the present invention, there can be provided a rubber composition that can prevent reversion in over-vulcanization and is excellent in abrasion resistance both in ordinary vulcanization and in over-vulcanization.

1. A rubber composition comprising a butadiene rubber in an amount of 60% by mass or more relative to the total amount of a rubber component therein,
and comprising, relative to 100 parts by mass of the rubber component,
a carbon black having an iodine adsorption of 100 to 170 g/kg and a DBP oil absorption of 100 to 140 cm³/100 g, in an amount of 40 to 70 parts by mass,
sulfur in an amount of 0.3 to 2.0 parts by mass, and
a vulcanization accelerator in an amount of 1.5 to 3 parts by mass.

2. The rubber composition according to claim 1, wherein the ratio by mass of the sulfur and the vulcanization accelerator, sulfur/vulcanization accelerator is from 0.2 to 0.9.

3. The rubber composition according to claim 1, comprising the sulfur in an amount of 0.3 to 1.5 parts by mass.

4. The rubber composition according to claim 3, wherein the ratio by mass of the sulfur and the vulcanization accelerator, sulfur/vulcanization accelerator is from 0.2 to 0.6.

5. The rubber composition according to claim 1, wherein the rubber component contains a natural rubber.

6. The rubber composition according to claim 1, wherein the vulcanization accelerator is a sulfenamide vulcanization accelerator.

7. The rubber composition according to claim 1, further comprising a thermoplastic material.

8. The rubber composition according to claim 1, wherein the iodine adsorption of the carbon black is from 120 to 170 g/kg.

9. A cover rubber for conveyor belt, comprising a rubber composition of claim 1.

10. A conveyor belt, comprising a rubber composition of claim 1.

11. The rubber composition according to claim 2, wherein the rubber component contains a natural rubber.

12. The rubber composition according to claim 2, wherein the vulcanization accelerator is a sulfenamide vulcanization accelerator.

13. The rubber composition according to claim 2, further comprising a thermoplastic material.

14. The rubber composition according to claim 2, wherein the iodine adsorption of the carbon black is from 120 to 170 g/kg.

15. A cover rubber for conveyor belt, comprising a rubber composition of claim 2.

16. A conveyor belt, comprising a rubber composition of claim 2.

17. The rubber composition according to claim 3, wherein the rubber component contains a natural rubber.

18. The rubber composition according to claim 3, wherein the vulcanization accelerator is a sulfenamide vulcanization accelerator.

19. The rubber composition according to claim 3, further comprising a thermoplastic material.

20. The rubber composition according to claim 3, wherein the iodine adsorption of the carbon black is from 120 to 170 g/kg.
